(19) United States
(12) Patent Application Publication
(10) Pub. No.: US 2008/0106168 A1
(43) Pub. Date: May 8, 2008

(54) MEMS COMB DEVICE

(75) Inventor: Yong-hwa PARK, Yongin-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD, Suwon-si (KR)

(21) Appl. No.: 11/740,328

(22) Filed: Apr. 26, 2007

(30) Foreign Application Priority Data
Nov. 3, 2006 (KR) 10-2006-0108538

(51) Int. Cl. H02N 1/00

(52) U.S. Cl. 310/309

(57) ABSTRACT

A MEMS comb device including a stationary comb fixed on a substrate, a movable comb separated from the substrate, and a spring movably supporting the movable comb. The stationary comb includes a stationary stage, and a plurality of stationary fingers protruding from the stationary stage and arranged in a plurality of layers which are separated at different intervals from the stationary stage. The movable comb includes a movable stage, and a plurality of movable fingers protruding from the movable stage and arranged in a plurality of layers which are separated at different intervals from the stationary stage. The plurality of stationary fingers and the plurality of movable fingers are arranged to correspond to each other according to a reverse order relationship between layers of the stationary fingers and the movable fingers, and the plurality of stationary fingers and the plurality of movable fingers that correspond to each other are arranged alternately with each other.

### CROSS-REFERENCE TO RELATED PATENT APPLICATION

This application claims priority from Korean Patent Application No. 10-2006-0108538, filed on Nov. 3, 2006, in the Korean Intellectual Property Office, the disclosure of which is incorporated herein in its entirety by reference.

### BACKGROUND OF THE INVENTION

1. Field of the Invention

Apparatuses consistent with the present invention relate to a micro electromechanical system (MEMS) device, and more particularly, to a MEMS comb device having an improved comb structure to enhance a driving force and sensing sensitivity.

2. Description of the Related Art

Recent rapid improvement of micro-machining technology has allowed development of MEMS devices with various functions. MEMS devices are being developed for a wide range of applications since they provide many advantages in regard to size, cost and reliability.

Particularly, a MEMS comb device includes a MEMS comb actuator that obtains a driving force using an electrostatic force between a stationary comb and a movable comb, and a MEMS comb sensor that induces an electrical signal by relative motion between a stationary comb and a movable comb. MEMS comb devices are used in various applications, including microdisplays, laser printers, precise control apparatuses, inertial sensors, and the like, for example.

FIG. 1 is a plan view illustrating a basic structure of a conventional MEMS comb actuator.

Referring to FIG. 1, a comb actuator 10 includes a stationary comb 20 and a movable comb 30 that are electrically isolated from each other. The stationary comb 20 is fixed on a substrate (not shown), and the movable comb 30 is separated from the substrate so as to be movable. The movable comb 30 is supported by a spring 40 connected to the substrate. The stationary comb 20 includes a stationary stage 22, and a plurality of stationary fingers 24 protruding from the stationary stage 22. The movable comb 30 includes a movable stage 32, and a plurality of movable fingers 34 protruding from the movable stage 32. The stationary fingers 24 and the movable fingers 34 are meshed with each other.

FIG. 2 is a view for describing a driving force obtained from the conventional MEMS comb actuator illustrated in FIG. 1.

Referring to FIG. 2, when a voltage V is applied between the stationary comb 20 and the movable comb 30, an electrostatic force (F) is generated by a change in capacitance formed in gaps (g) between the stationary fingers 24 and the movable fingers 34. Thus, the movable comb 30 supported by the spring 40 of FIG. 1 is moved toward the stationary comb 20.

Here, the generated electrostatic force (F) may be expressed by Equation 1 below.

$$F = \frac{ɛ hN}{2 d} {V}^{2} \qquad [ Equation 1 ]$$

where ε denotes a dielectric constant of the gaps (g) between the fingers 24 and 34, N denotes the number of gaps (g), d denotes the width of the gaps (g), h denotes the height of the gaps (g), and V denotes an applied voltage.

Here, the dielectric constant ε is a constant defined by a material forming the gaps (g) between the fingers 24 and 34, and the number N of gaps (g) is in proportion to the lengths of the combs 20 and 30. On the assumption that the height h of the gaps (g) and the voltage V are constant, Equation 2 below can be obtained.

$$F ∝ \frac{N}{d} ∝ \frac{L}{d} \qquad [ Equation 2 ]$$

It can be seen from Equation 2 that an electrostatic force (F) obtained from the conventional comb actuator is in inverse proportion to the width d of the gaps (g), and in proportion to the number N of gaps (g) and as such the length L of the combs 20 and 30.

Therefore, the two following methods have been conventionally used to improve a driving force of the comb actuator.

The first method is to reduce the width d of the gaps (g) to improve a driving force. However, this method is disadvantageous in that the amount to which the width d of the gaps (g) can be reduced is limited by restrictions of micromachining processes. That is, since the height h of the gaps (g) must also reduced in response to the reduction of the width d of the gaps (g), no increase in the driving force can be expected.

The second method is to increase the length L of the comb and, thus, increase the number N of gaps (g) to improve a driving force. However, this method is problematic in that the entire size of a device employing such a comb actuator is undesirably increased due to an increase in space occupied by the comb actuator within the device.

As mentioned above, a driving force obtained from the conventional comb actuator is limited. Therefore, to enhance the driving force, a plurality of comb actuators are used in one device, which undesirably increases the size of the device employing the plurality of comb actuators.

### SUMMARY OF THE INVENTION

Exemplary embodiments of the present invention provide a MEMS comb device having a comb structure.

According to an exemplary aspect of the present invention, there is provided a MEMS comb device including a stationary comb fixed on a substrate; a movable comb separated from the substrate; and a spring movably supporting the movable comb. The stationary comb includes a stationary stage, and a plurality of stationary fingers protruding from the stationary stage and being arranged in a plurality of layers which are separated at different intervals from the stationary stage. The movable comb includes a movable stage, and a plurality of movable fingers protruding from the movable stage and being arranged in a plurality of layers which are separated at different intervals from the movable stage. The plurality of stationary fingers and the plurality of movable fingers are arranged to correspond to each other according to a reverse order relationship between layers of the stationary fingers and the movable fingers, and the plurality of stationary fingers and the plurality of movable fingers that correspond to each other are arranged alternately with each other.

The plurality of stationary fingers may include stationary fingers arranged in a first layer of the stationary comb and protruding directly from the stationary stage, and stationary fingers arranged in higher layers and formed as branches diverging from support fingers protruding from the stationary stage. The plurality of movable fingers may include movable fingers arranged in a first layer of the movable comb and protruding directly from the movable stage, and movable fingers arranged in higher layers and formed as branches diverging from support fingers protruding from the movable stage.

The plurality of stationary fingers may be arranged in first and second layers, and the plurality of movable fingers may be arranged in first and second layers. The stationary fingers arranged in the first layer of the stationary comb correspond to the movable fingers arranged in the second layer of the movable comb, and the stationary fingers arranged in the second layer of the stationary comb correspond to the movable fingers arranged in the first layer of the movable comb. The stationary fingers arranged in the second layer of the stationary comb, and the movable fingers arranged in the second layer of the movable comb may be formed as branches. Three or more branches may diverge from each of the support fingers.

The plurality of stationary fingers may be arranged in first, second and third layers, and the plurality of movable fingers may be arranged in first, second and third layers. The stationary fingers arranged in the first layer of the stationary comb correspond to the movable fingers arranged in the third layer of the movable comb. The stationary fingers arranged in the second layer of the stationary comb correspond to the movable fingers arranged in the second layer of the movable comb. The stationary fingers arranged in the third layer of the stationary comb correspond to the movable fingers arranged in the first layer of the movable comb. The stationary fingers arranged in the second layer and the third layer of the stationary comb, and the movable fingers arranged in the second layer and the third layer of the movable comb may be formed as branches diverging from the support fingers. Three or more branches may diverge from each of the support fingers.

The support fingers for the stationary comb and the movable comb may have thicknesses greater than those of other fingers.

The movable comb may be disposed on the same plane as the stationary comb, and may be moved in a direction parallel to the upper surface of the substrate.

The movable comb may be disposed at a different height from that of the stationary comb, and thus may be moved in a direction perpendicular to the upper surface of the substrate.

The MEMS comb device may serve as an actuator that generates a driving force to move the movable comb by applying a voltage between the stationary comb and the movable comb.

The MEMS comb device may serve as a sensor that generates an electric signal due to a relative motion between the stationary comb and the movable comb.

### BRIEF DESCRIPTION OF THE DRAWINGS

The above and other aspects of the present invention will become more apparent by describing in detail exemplary embodiments thereof with reference to the attached drawings in which:

FIG. 1 is a plan view illustrating a basic structure of a conventional MEMS comb actuator;

FIG. 2 is a view for describing a driving force obtained from the conventional MEMS comb actuator of FIG. 1;

FIG. 3 is a plan view illustrating a structure of a MEMS comb actuator according to an exemplary embodiment of the present invention;

FIG. 4 is a partial perspective view illustrating the MEMS comb actuator of FIG. 3, according to an exemplary embodiment of the present invention;

FIG. 5 is a partial plan view for describing a driving force obtained from the MEMS comb actuator of FIG. 3, according to an exemplary embodiment of the present invention;

FIG. 6 is a partial plan view illustrating a structure of a MEMS comb actuator according to another exemplary embodiment of the present invention, and used to describe a driving force obtained from the MEMS comb actuator;

FIG. 7 is a partial plan view illustrating a structure of a MEMS comb actuator according to another exemplary embodiment of the present invention, and used to describe a driving force obtained from the MEMS comb actuator;

FIG. 8 is a vertical cross-sectional view illustrating a structure of a MEMS comb actuator according to another exemplary embodiment of the present invention;

FIG. 9 is a partial plan view for describing a driving force obtained from the MEMS comb actuator of FIG. 8, according to an exemplary embodiment of the present invention;

FIG. 10 is a graph illustrating a driving force improvement made by the MEMS comb actuators of FIGS. 3, 6 and 7, according to exemplary embodiments of the present invention; and

FIG. 11 is a graph illustrating driving force improvement made by a MEMS comb actuator of FIG. 8, according to an exemplary embodiment of the present invention.

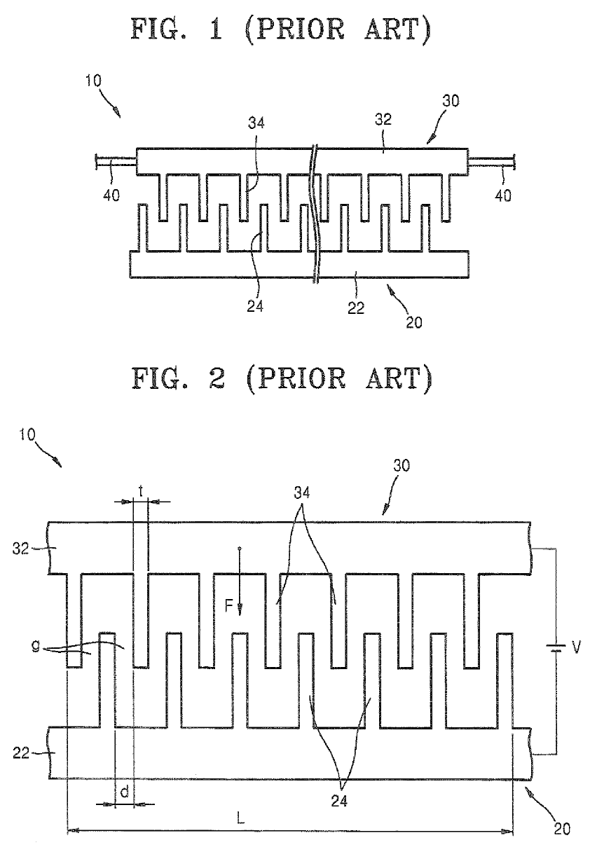

### DETAILED DESCRIPTION OF EXEMPLARY EMBODIMENTS OF THE INVENTION

The present invention will now be described more fully with reference to the accompanying drawings, in which exemplary embodiments of the invention are shown.

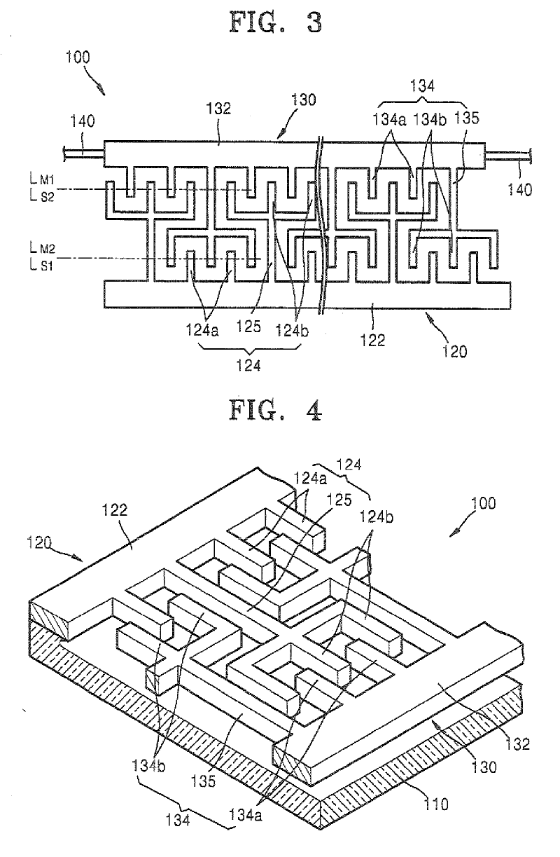

FIG. 3 is a plan view illustrating a structure of a MEMS comb actuator according to an exemplary embodiment of the present invention, and FIG. 4 is a partial perspective view of the MEMS comb actuator of FIG. 3, according to an embodiment of the present invention.

Referring to FIGS. 3 and 4, a MEMS comb actuator 100 according to an exemplary embodiment of the present invention includes a stationary comb 120 fixed on a substrate 110, a movable comb 130 separated from the substrate 110, and a spring 140 movably supporting the movable comb 130.

The substrate 110 may be formed of silicon, but it will be appreciated that the substrate 110 may be formed of another material with good workability, for example, glass.

The stationary comb 120 includes a stationary stage 122 fixed on the substrate 110, and a plurality of stationary fingers 124 protruding from one side of the stationary stage 122.

The movable comb 130 is separated from the substrate 110 so as to be movable, and is disposed to face the stationary comb 120. Specifically, the movable comb 130 is disposed on the same plane as the stationary comb 120 so as to be movable in a direction parallel to the upper surface of the substrate 110. The comb actuator 100 having this structure is generally called an in-plane comb actuator. The movable comb 130 includes a movable stage 132 and a plurality of movable fingers 134 protruding from one side of the movable stage 132. The movable stage 132 is supported on the substrate 110 through the spring 140 connected to both ends of the movable stage 132.

The plurality of stationary fingers 124 are formed in two layers, namely, first and second layers L_{S1} and L_{S2}, and the plurality of movable fingers 134 are also arranged in two layers, namely, first and second layers L_{M1} and L_{M2}. Here, the layers L_{S1} and L_{S2}, and L_{M1} and L_{M2} refer to layers formed by stationary and movable finger arrays. That is, the plurality of stationary fingers 124 are arranged in the first and second layers L_{S1} and L_{S2} that are separated at different intervals from the stationary stage 122, and the plurality of moving fingers 134 are arranged in the two first and second layers L_{M1} and L_{M2} that are separated at different intervals from the movable stage 132.

Specifically, the plurality of stationary fingers 124 include first stationary fingers 124a arranged in the first layer L_{S1} which is adjacent to the stationary stage 122, and second stationary fingers 124b arranged in the second layer L_{S2} spaced apart from the stationary stage 122. The first stationary fingers 124a protrude directly from one side of the stationary stage 122. The second stationary fingers 124b are formed as branches diverging from stationary support fingers 125 protruding from the stationary stage 122. In the current exemplary embodiment, three branches, namely, three second stationary fingers 124b, diverge from each of the stationary support fingers 125. The plurality of movable fingers 134 include first movable fingers 134a arranged in the first layer L_{M1} which is adjacent to the movable stage 132, and second movable fingers 134b arranged in the second layer L_{M2} spaced apart from the movable stage 132. The first movable fingers 134a protrude directly from one side of the movable stage 132. The second movable fingers 134b are formed as branches diverging from movable support fingers 135. In the current exemplary embodiment, three branches, that is, three second movable fingers 134b, diverge from each of the movable support fingers 135.

The first stationary fingers 124a arranged in the first layer L_{S1} of the stationary comb 120 are arranged alternately with the second movable fingers 134b arranged in the second layer L_{M2} of the movable comb 130. The second stationary fingers 124b arranged in the second layer L_{S2} of the stationary comb 120 are arranged alternately with the first movable fingers 134a arranged in the first layer L_{M1} of the movable comb 130. That is, the first stationary fingers 124a are disposed to mesh with the second movable fingers 134b, and the second stationary fingers 124b are disposed to mesh with the first movable fingers 134a.

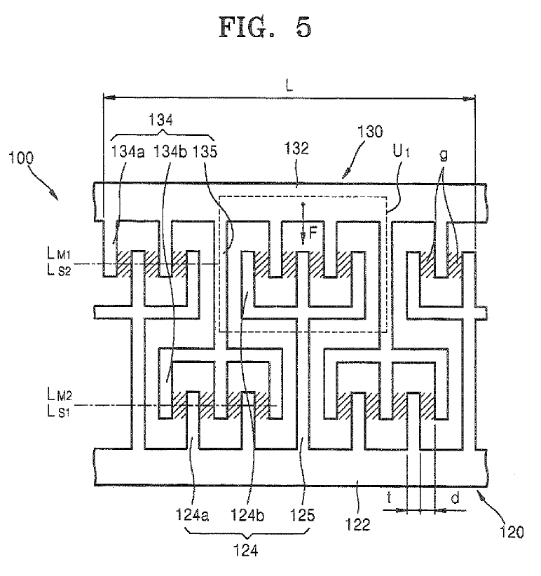

A driving force obtained from the MEMS comb actuator 100 of FIG. 3 having the aforementioned structure will now be described with reference to FIG. 5.

In FIG. 5, the comb actuator 100 of FIG. 3 is partially illustrated as having the same length as the conventional comb actuator illustrated in FIG. 2 to facilitate a comparison between the comb actuator 100 of FIG. 3 and the conventional comb actuator 10 of FIG. 2.

Referring to FIG. 5, a plurality of gaps (g) are formed between the plurality of stationary fingers 124 and the plurality of movable fingers 134. The total number of gaps (g) illustrated in FIG. 5 is 26, which is twice the number of gaps (g) illustrated in FIG. 2, the number of gaps (g) illustrated in FIG. 2 being 13. However, when the movable comb 130 is moved, a capacitance change does not occur in gaps between the second stationary fingers 124b and the movable support fingers 135, and in gaps between the second movable fingers 134b and the stationary support fingers 125. Thus, those gaps do not contribute to generating an electrostatic force (F). When the movable comb 130 is moved, the capacitance change occurs only in gaps (g) indicated by oblique lines in FIG. 5, namely, in gaps (g) between the first stationary fingers 124a and the second movable fingers 134b and gaps (g) between the second stationary fingers 124b and the first movable fingers 134a. Only those gaps (g) illustrated by the oblique lines contribute to generating an electrostatic force (F), and are called effective gaps. The number of effective gaps (g) illustrated in the exemplary embodiment of FIG. 5 is 17, which is greater than 13, the number of gaps illustrated in FIG. 2.

The number of gaps (g) may be expressed by Equations 3 and 4 below. Equation 3 provides a relationship regarding the number N₀ of gaps of the conventional comb actuator 10 of FIG. 2, and Equation 4 provides a relationship regarding the number N₁ of effective gaps (g) of the comb actuator 100 of FIG. 5. In Equations 3 and 4, it is assumed that the widths d of the gaps (g), and the thicknesses t of the fingers are the same.

$$\begin{matrix}{N}_{0} = \frac{L}{( d + t )} = \frac{L}{2 d} & [ Equation 3 ] \\ \begin{matrix}{N}_{1} = \frac{L}{( d + t )} \times \frac{4}{6} \times 2 \\ = \frac{L}{2 d} \times \frac{4}{6} \times 2 \\ = \frac{2 L}{3 d} \approx 1.33 {N}_{0}\end{matrix} & [ Equation 4 ]\end{matrix}$$

In Equation 4, 4/6 represents that four gaps out of six gaps within a unit area indicated by U₁ may be effective gaps, and 2 represents that the gaps may be arranged in two layers.

From comparison between Equations 3 and 4, it can be seen that the number N₁ of effective gaps (g) of the comb actuator 100 of FIG. 5 is greater than the number of N₀ of gaps of the conventional comb actuator 10 of FIG. 2 by about 33%. Also, since an electrostatic force (F) is in proportion to the number of effective gaps (g) as expressed in Equation 2, it can be seen that an electrostatic force (F) generated from the comb actuator of FIG. 5 is greater than that generated from the conventional comb actuator 10 of FIG. 2 by about 33%.

As described above, in the case where the comb actuator 100 of FIG. 5 has the same length as that of the conventional comb actuator 10 of FIG. 2, a driving force obtained from the comb actuator 100 of FIG. 5 can be improved compared to a driving force obtained from the conventional comb actuator 10 of FIG. 2.

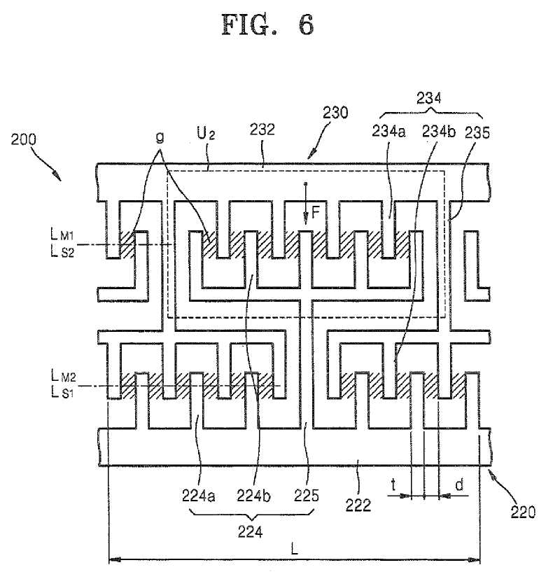

FIG. 6 is a partial plan view illustrating a structure of a MEMS comb actuator according to another exemplary embodiment of the present invention, and is used to describe a driving force obtained from the MEMS comb actuator. In FIG. 6, the MEMS comb actuator 200 is partially illustrated as having the same length as the conventional MEMS comb actuator illustrated in FIG. 2 to facilitate comparison between the comb actuator of FIG. 6 and the conventional comb actuator 10 of FIG. 2. The comb actuator 200 of FIG. 6 has a similar structure as the comb actuator 100 of FIG. 3, except for the structure of the fingers, and therefore, only differences between the comb actuator 200 of FIG. 6 and the comb actuator 100 of FIG. 3 will be described.

Referring to FIG. 6, the MEMS comb actuator 200 according to the current exemplary embodiment of the present invention includes a stationary comb 220 and a movable comb 230. Although not illustrated, the MEMS comb actuator 200 further includes a substrate 10 and a spring 140 like the comb actuator of FIG. 3.

The stationary comb 220 includes a stationary stage 222, and a plurality of stationary fingers 224 protruding from one side of the stationary stage 222. The movable comb 230 is disposed on the same plane as the stationary comb 220 so as to face the stationary comb 220. The movable comb 230 includes a movable stage 232, and a plurality of movable fingers 234 protruding from one side of the movable stage 232.

The plurality of stationary fingers 224 are arranged in two layers, namely, first and second layers L_{S1} and L_{S2}, and the plurality of movable fingers 234 are also arranged in two layers, namely, first and second layers L_{M1} and L_{M2}. That is, the plurality of stationary fingers 224 are arranged in the first and second layers L_{S1} and L_{S2} that are separated at different intervals from the stationary stage 222. Also, the plurality of movable fingers 234 are arranged in the first and second layers L_{M1} and L_{M2} that are separated at different intervals from the movable stage 232.

Specifically, the plurality of stationary fingers 224 include first stationary fingers 224a arranged in the first layer L_{S1} which is adjacent to the stationary stage 222, and second stationary fingers 224b arranged in the second layer L_{S2} spaced apart from the stationary stage 222. The first stationary fingers 224 protrude directly from one side of the stationary stage 222. The second stationary fingers 224b are formed as branches diverging from stationary support fingers 225. In the current exemplary embodiment, five branches, namely, five second stationary fingers 224b, diverge from each of the stationary support fingers 225. Also, the plurality of movable fingers 234 include first movable fingers 234a arranged in the first layer L_{M1} which is adjacent to the movable stage 232, and second movable fingers 234b arranged in the second layer L_{M2} spaced apart from the movable stage 232. The first movable fingers 234a protrude directly from one side of the movable stage 232, and the second movable fingers 234b are formed as branches diverging from movable support fingers 235 protruding from the movable stage 232. In the current exemplary embodiment, five branches, namely, five second movable fingers 234b, diverge from each of the movable support fingers 235.

The first stationary fingers 224a arranged in the first layer L_{S1} of the stationary comb 220 are arranged alternately with the second movable fingers 234b arranged in the second layer L_{M2} of the movable comb 230. The second stationary fingers 224b arranged in the second layer L_{S2} of the stationary comb 220 are arranged alternately with the first movable fingers 234a arranged in the first layer L_{M1} of the movable comb 230. That is, the first stationary fingers 224a are arranged to mesh with the second movable fingers 234b, and the second stationary fingers 224b are arranged to mesh with the first movable fingers 234a.

A driving force obtained from the MEMS comb actuator 200 of FIG. 6 having the aforementioned structure will now be described.

As illustrated in the exemplary embodiment of FIG. 6, the total number of gaps (g) formed between the plurality of stationary fingers 224 and the plurality of movable fingers 234 is 26, and thus is the same as the total number of gaps of the comb actuator 100 of FIG. 5. However, in FIG. 6, the number of effective gaps (g) indicated by oblique lines and contributing to electrostatic force generation is 20. The effective gaps are gaps (g) between the first stationary fingers 224a and the second movable fingers 234b and between the second stationary fingers 224b and the first movable fingers 234a. Hence, the number of effective gaps (g) of the MEMS comb actuator 200 illustrated in FIG. 6 is greater than the 17 effective gaps of the comb actuator 100 illustrated in FIG. 5, and is much greater than the 13 gaps of the conventional comb actuator 10 illustrated in FIG. 2.

The number N₂ of effective gaps (g) of the comb actuator 200 of FIG. 6 may be expressed by Equation 5 below. Here, it is assumed that the widths d of the gaps (g) and the thicknesses t of the fingers are the same.

$$\begin{matrix}{N}_{2} = \frac{L}{( d + t )} \times \frac{8}{10} \times 2 \\ = \frac{L}{2 d} \times \frac{8}{10} \times 2 \\ = \frac{4 L}{5 d} = 1.6 {N}_{0}\end{matrix} \qquad [ Equation 5 ]$$

where 8/10 represents that eight gaps out of ten within a unit area indicated by U₂ in FIG. 6 are effective gaps, and 2 represents that the gaps are arranged in two layers.

From a comparison between Equations 3 and 5, it can be seen that the number N₂ of effective gaps (g) of the comb actuator 200 of FIG. 6 is greater than the number N₀ of gaps of the conventional comb actuator 10 of FIG. 2 by about 60%. Also, since electrostatic force (F) is proportional to the number of effective gaps (g) as expressed in Equation 2, it can be seen that the electrostatic force (F) generated from the comb actuator 200 of FIG. 6 is greater than that of the conventional comb actuator 10 of FIG. 2 by about 60%. It can also be seen that the electrostatic force (F) that can be obtained from the comb actuator 200 of FIG. 6 is higher than the electrostatic force (F) that can be obtained from the comb actuator 100 of FIG. 3.

As mentioned above, the number of effective gaps (g) in the same length L is increased due to an increase in the number of second stationary fingers 224b diverging from one stationary support finger 225, and an increase in the number of second movable fingers 234b diverging from one movable support finger 235. As such, a higher driving force can be obtained.

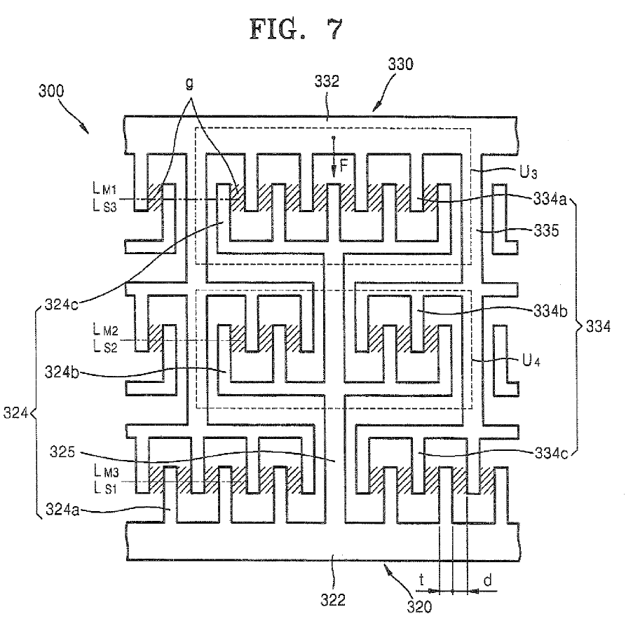

FIG. 7 is a partial plan view for describing a structure of a MEMS comb actuator according to another exemplary embodiment of the present invention, and is used to describe a driving force obtained from the MEMS comb actuator. In FIG. 7, the MEMS comb actuator 300 is partially illustrated as having the same length as the conventional MEMS comb actuator illustrated in FIG. 2 to facilitate a comparison with the conventional comb actuator 10 of FIG. 2. Also, the MEMS comb actuator 300 of FIG. 7 has the same structure as the MEMS comb actuator 100 of FIG. 3, except for a finger structure, and therefore only differences between the MEMS comb actuator 300 of FIG. 7 and the MEMS comb actuator 100 of FIG. 3 will be mainly described.

Referring to FIG. 7, the MEMS comb actuator 300 according to another exemplary embodiment of the present invention includes a stationary comb 320 and a movable comb 330. Although not shown, the MEMS comb actuator 300 of FIG. 7 further includes a substrate 110 and a spring 140 like the MEMS comb actuator 100 of FIG. 3.

The stationary comb 320 includes a stationary stage 322, and a plurality of stationary fingers 324 protruding from one side of the stationary stage 322. The movable comb 330 is disposed on the same plane as the stationary comb 320 so as to face the stationary comb 32. The movable comb 330 includes a movable stage 332, and a plurality of movable fingers 334 protruding from one side of the movable stage 332.

The plurality of stationary fingers 324 are arranged in three layers, namely, first, second and third layers L_{S1}, L_{S2} and L_{S3}, and the plurality of movable fingers 334 are arranged in three layers, namely, first, second and third layers L_{M1}, L_{M2} and L_{M3}. That is, the plurality of stationary fingers 324 are arranged in the first, second and third layers L_{S1}, L_{S2} and L_{S3} that are separated at different intervals from the stationary stage 322. Likewise, the plurality of movable fingers 334 are arranged in the first, second and third layers L_{M1}, L_{M2} and L_{M3} that are separated at different intervals from the movable stage 332.

Specifically, the plurality of stationary fingers 324 include first stationary fingers 324a arranged in the first layer L_{S1} which is adjacent to the stationary stage 322, and second stationary fingers 324b and third stationary fingers 324c respectively arranged in the second layer L_{S2} and the third layer L_{S3} that are spaced apart from the stationary stage 322. The first stationary fingers 324a protrude directly from one side of the stationary stage 322. The second stationary fingers 324b and the third stationary fingers 324c are formed as branches diverging from stationary support fingers 325 protruding from the stationary stage 322. In the current exemplary embodiment, four branches, namely, four second stationary fingers 324b, diverge from a middle portion of each of the stationary support fingers 325, and five branches, namely, five third stationary fingers 324c, diverge from an end portion of each of the stationary support fingers 325.

The plurality of movable fingers 334 include first movable fingers 334a arranged in the first layer L_{M1} which is adjacent to the movable stage 332, and second movable fingers 334b and third movable fingers 334c respectively arranged in the second layer L_{M2} and the third layer L_{M3} that are spaced apart from the movable stage 322. The first movable fingers 334a protrude directly from one side of the movable stage 332, and the second movable fingers 334b and the third movable fingers 334c are formed as branches diverging from movable support fingers 335 protruding from the movable stage 332. In the current exemplary embodiment, four branches, namely, four second movable fingers 334b, diverge from a middle portion of each of the movable support fingers 335, and five branches, namely, five third movable fingers 334c, diverge from an end portion of each of the movable support fingers 335.

Since the stationary support fingers 325 and the movable support fingers 335 must support a plurality of fingers, the stationary and movable support fingers 325 and 335 may be thicker than other fingers in order to improve strength. The increasing of the thicknesses of the stationary and movable support fingers 325 and 335 may also be applied to the comb actuators 100 and 200 illustrated in FIGS. 3 and 6 in order to improve strength.

The plurality of stationary fingers 324 and the plurality of movable fingers 334 are arranged to correspond to each other according to a reverse order relationship therebetween. Specifically, the first stationary fingers 324a arranged in the first layer L_{S1} of the stationary comb 320 are arranged alternately with the third movable fingers 334c arranged in the third layer L_{M3} of the movable comb 330. The second stationary fingers 324b arranged in the second layer L_{S2} of the stationary comb 320 are arranged alternately with the second movable fingers 334b arranged in the second layer L_{M2} of the movable comb 330. The third stationary fingers 324c arranged in the third layer L_{S3} of the stationary comb 320 are arranged alternately with the first movable fingers 334a arranged in the first layer L_{M1} of the movable comb 330. That is, the first stationary fingers 324a are arranged to mesh with the third movable fingers 334c, the second stationary fingers 324b are arranged to mesh with the second movable fingers 334b, and the third stationary fingers 324c are arranged to mesh with the first movable fingers 334a.

A driving force obtained from the MEMS comb actuator 300 of FIG. 7 having the aforedescribed structure will now be described.

As illustrated in FIG. 7, a total of 39 gaps (g) are formed between the plurality of stationary fingers 324 and the plurality of movable fingers 334. Hence, the total number of gaps (g) illustrated in FIG. 7 is greater than the total numbers of gaps (g) of the comb actuators 100 and 200 of FIGS. 5 and 6. Also, the number of effective gaps (g) indicated by oblique lines in FIG. 7 and contributing to electrostatic force (F) generation is 27, which is greater than the 17 effective gaps (g) of the comb actuator 100 illustrated in FIG. 5 and the 20 effective gaps of the comb actuator 200 illustrated in FIG. 6, and also greater than the 13 effective gaps (g) of the conventional comb actuator 10 illustrated in FIG. 2. Here, the effective gaps (g) are gaps (g) between the first stationary fingers 324a and the third movable fingers 334c, between the second stationary fingers 324b and the second movable fingers 334b and between the third stationary fingers 324c and the first movable fingers 334a, which contribute to electrostatic force (F) generation.

The number N₃ of effective gaps (g) of the comb actuator 300 of FIG. 7 can be expressed by Equation 6 below. Here, it is assumed that the widths d of the gaps (g) and the thicknesses t of the fingers are the same.

$${N}_{3} = \frac{L}{2 d} \times \frac{8}{10} \times 2 + \frac{L}{2 d} \times \frac{6}{10} = \frac{11 L}{10 d} = 2.2 {N}_{0} \qquad [ Equation 6 ]$$

where 8/10 represents that 8 gaps out of 10 within a unit area indicated by U₃ in FIG. 7 are effective gaps, 2 represents that these gaps are arranged in two opposite layers of three layers, 6/10 represents that 6 gaps out of 10 within a unit area indicated by U₄ in FIG. 7 are effective gaps, and these gaps are arranged in one middle layer of the three layers.

From comparison between Equation 3 and Equation 6 above, it can be seen that the number N₃ of effective gaps (g) of the comb actuator 300 of FIG. 7 is greater than the number N₀ of gaps of the conventional comb actuator 10 of FIG. 2 by about 120%. This means that an electrostatic force (F) generated from the comb actuator 300 of FIG. 7 is higher than an electrostatic force (F) generated from the conventional comb actuator 10 of FIG. 2 by about 120%. Also, it can also be seen that the electrostatic force (F) that can be obtained from the comb actuator 300 of FIG. 7 is greater than the electrostatic force (F) that can be obtained from the comb actuators 100 and 200 of FIGS. 5 and 6.

As described above, as the number of layers in which the plurality of stationary fingers 324 and the plurality of movable fingers 334 are arranged is increased, the number of effective gaps (g) within the same length L increases, so that a higher driving force can be obtained.

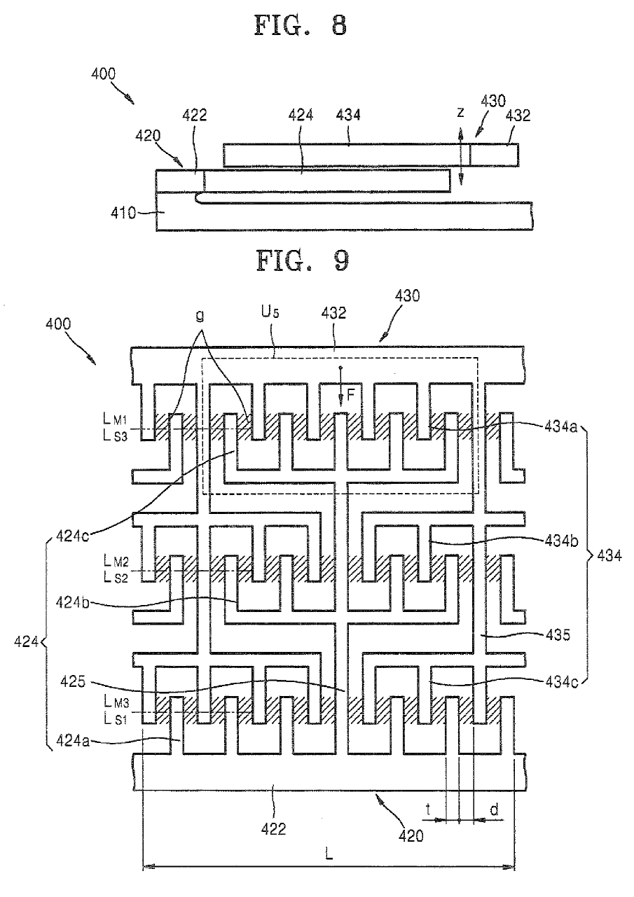

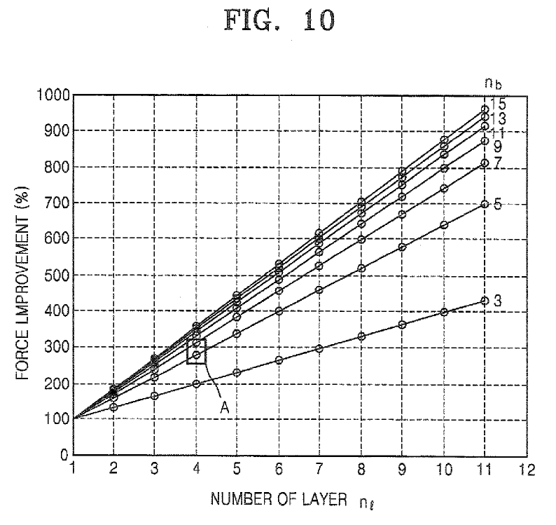

FIG. 8 is a vertical cross-sectional view illustrating a structure of a MEMS comb actuator according to another exemplary embodiment of the present invention, and FIG. 9 is a partial plan view for describing a driving force obtained from the MEMS comb actuator illustrated in FIG. 8, according to an exemplary embodiment of the present invention.

Referring to FIG. 8, a MEMS comb actuator 400 includes a stationary comb 420 fixed on a substrate 410, and a movable comb 430 separated from the substrate 41 0. Although not shown, the MEMS comb actuator 400 of FIG. 8 further includes a spring 140 like the comb actuator 100 illustrated in FIG. 3.

The stationary comb 420 includes a stationary stage 422 fixed on the substrate 410, and a plurality of stationary fingers 424 protruding from one side of the stationary stage 422.

The movable comb 430 is separated from the substrate 410 so as to be movable, and is disposed at a different height from that of the stationary comb 420. Specifically, the movable comb 430 is disposed higher than the stationary comb 420 so as to be movable in a vertical direction (i.e., a z direction) with respect to the upper surface of the substrate 410. The comb actuator 400 having such a structure is generally called a vertical comb actuator. The movable comb 430 includes a movable stage 432, and a plurality of movable fingers 430 protruding from one side of the movable stage 432.

As illustrated in FIG. 9, the plane structure of the comb actuator 400 of FIG. 8 is similar to that of the comb actuator 300 of FIG. 7, and therefore the description of the plane structure of the comb actuator 400 will be made briefly.

The plurality of stationary fingers 424 are arranged in three layers, namely, first, second and third layers L_{S1}, L_{S2} and L_{S3} that are separated at different intervals from the stationary stage 422. Also, the plurality of movable fingers 434 are arranged in three layers, namely, first, second and third layers L_{M1}, L_{M2} and L_{M3} that are separated at different intervals from the movable stage 432.

Specifically, the plurality of stationary fingers 424 include first stationary fingers 424a arranged in the first layer L_{S1} which is adjacent to the stationary stage 422, and second stationary fingers 424b and third stationary fingers 424c respectively arranged in the second layer L_{S2} and the third layer L_{S3} that are spaced apart from the stationary stage 422. The first stationary fingers 424a protrude directly from one side of the stationary stage 422, and the second stationary fingers 424b and the third stationary fingers 424c are formed as branches diverging from stationary support fingers 425 protruding from the stationary stage 422.

The plurality of movable fingers 434 include first movable fingers 434a arranged in the first layer L_{M1} which is adjacent to the movable stage 432, and second movable fingers 434b and third movable fingers 434c respectively arranged in the second layer L_{M2} and the third layer L_{M3} that are spaced apart from the movable stage 432. The first movable stage 434a protrude directly from one side of the movable stage 432. The second movable fingers 434b and the third movable fingers 434c are formed as branches diverging from movable support fingers 435 protruding from the movable stage 432.

Since the stationary support fingers 425 and the movable support fingers 435 must support a plurality of fingers, the stationary and movable support fingers 425 and 435 may be thicker than other fingers in order to increase strength.

Also, the plurality of stationary fingers 424 and the plurality of movable fingers 434 are arranged to correspond to each other according to a reverse order relationship therebetween. The detailed description of this arrangement will be omitted.

A driving force obtained from the MEMS comb actuator 400 of FIG. 9 having such a structure will now be described.

As illustrated in FIG. 9, a total of 39 gaps (g) are formed between the plurality of stationary fingers 424 and the plurality of movable fingers 434. For the vertical comb actuator 400, as indicated by oblique lines in FIG. 9, all of the gaps (g) act as effective gaps (g) contributing generation of an electrostatic force (F). This is because the movable comb 430 moves in a vertical direction, and thus, a capacitance change occurs in gaps (g) between the second and third stationary fingers 424b and 424c and the movable support fingers 435, and between the second and third movable fingers 434b and 434c and the stationary support fingers 425.

Accordingly, the number of effective gaps (g) of the comb actuator 400 of FIG. 9 is greater than the numbers of effective gaps (g) of the comb actuators 100, 200 and 300 illustrated in FIGS. 5, 6 and 7.

The number N₄ of effective gaps (g) of the comb actuator 400 of FIG. 9 may be expressed by Equation 7 below. Here, it is assumed that the widths d of the gaps (g) and the thicknesses t of the fingers are the same.

$${N}_{4} = \frac{L}{( d + t )} \times \frac{10}{10} \times 3 = \frac{L}{2 d} \times \frac{10}{10} \times 3 = \frac{3 L}{2 d} = 3 {N}_{0} \qquad [ Equation 7 ]$$

where 10/10 represents that all of 10 gaps within a unit area indicated by U₅ in FIG. 9 serve as effective gaps, and 3 represents that these gaps are arranged in three layers.

From comparison between Equations 3 and 7, it can be seen that the number N₄ of effective gaps (g) of the comb actuator 400 of FIG. 9 is three times greater than the number N₀ of effective gaps (g) of the conventional comb actuator 10 of FIG. 2. This means that the electrostatic force (F) generated from the comb actuator 400 of FIG. 9 is three times higher than the electrostatic force (F) generated from the conventional comb actuator 10 of FIG. 2. Also, the electrostatic force (F) that can be obtained from the vertical comb actuator 400 of FIG. 9 is greater than the electrostatic force (F) that can be obtained from the in-plane comb actuators illustrated in FIGS. 3, 6 and 7.

FIG. 10 is a graph illustrating driving force improvements made by in-plane MEMS comb actuators as illustrated in FIGS. 3, 6 and 7.

Equations 4, 5 and 6, regarding the number of effective gaps in the MEMS comb actuators of FIGS. 3, 6 and 7, according to exemplary embodiments of the present invention, are generalized into Equations 8 through 11 below.

In the Equations below, n_{b} denotes the number of branches, namely, the number of stationary fingers or movable fingers diverging from one support finger and arranged in one layer, and nₗ denotes the number of layers.

$${N}_{U} = \frac{L}{2 d} \times \frac{{n}_{b} - 1}{{n}_{b}} \qquad [ Equation 8 ]$$

Equation 8 is an equation to calculate the number Nᵤ of effective gaps arranged in a layer adjacent to a movable stage.

$${N}_{L} = \frac{L}{2 d} \times \frac{{n}_{b} - 1}{{n}_{b}} \qquad [ Equation 9 ]$$

Equation 9 is an equation to calculate the number N_{L} of effective gaps arranged in a layer adjacent to a stationary stage.

$${N}_{M} = \frac{L}{2 d} \times \frac{{n}_{b} - 2}{{n}_{b}} \qquad [ Equation 10 ]$$

Equation 10 is an equation to calculate the number N_{M} of effective gaps arranged in a middle layer.

Equation 11 shown below can be used for calculating the total number N of effective gaps.

$$\begin{matrix}N = {N}_{U} + {N}_{L} + {N}_{M} ( {n}_{l} - 2 ) \\ = \frac{L}{2 d} \times \frac{1}{{n}_{b}} ( {n}_{l} {n}_{b} - 2 {n}_{l} + 2 )\end{matrix} \qquad [ Equation 11 ]$$

Equation 12 below can be obtained from Equation 11 and Equation 3 of the conventional comb actuator. Equation 12 is a general formula for electrostatic force (F) in the in-plane comb actuator as illustrated FIGS. 3, 6 and 7 according to exemplary embodiments of the present invention.

$$F = \frac{1}{{n}_{b}} ( {n}_{l} {n}_{b} - 2 {n}_{l} + 2 ) \times 100 ( \% ) \qquad [ Equation 12 ]$$

Electrostatic force (F) can be calculated using Equation 12 while changing the number nₗ of layers and the number n_{b} of branches, thereby obtaining the graph of FIG. 10.

From the graph of FIG. 10, it can be seen that electrostatic force (F) increases in proportion to the number of layers while the number of branches is fixed. Also, it can be seen that as the number of branches is increased while the number of layers is fixed, the electrostatic force (F) rapidly increases at an initial stage, and then the increase rate of the electrostatic force (F) gradually reduces.

As the numbers of layers and branches are increased, an electrostatic force (F) is increased. However, if the increase in the numbers of layers and branches is excessive, structural reliability of the fingers may be degraded. Therefore, an appropriate numbers of layers and branches should be selected by considering the structural reliability. The appropriate numbers of layers and branches may be selected within an area A in the graph of FIG. 10, that is, an area in which the number of layers is four, and the number of branches is 5 to 7. Also, the structural reliability can be maintained in this area. When the numbers of layers and branches are four and five, respectively, electrostatic force (F) is improved by about 280% compared to the conventional art.

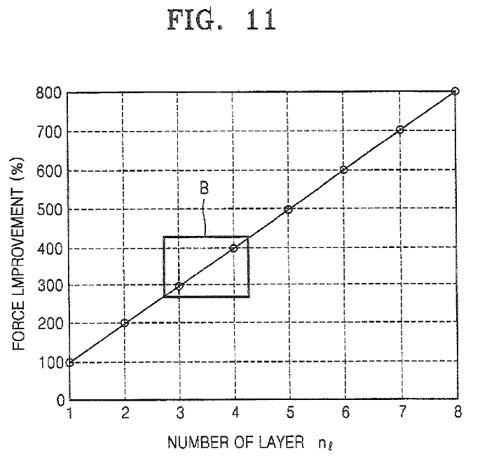

FIG. 11 is a graph illustrating a driving force improvement made by a vertical MEMS comb actuator as illustrated in FIGS. 8 and 9.

Equation 7 regarding the number N of effective gaps (g) in the vertical MEMS comb actuator 400 of FIGS. 8 and 9 can be written into Equation 13 below.

$$N = \frac{L}{2 d} \times {n}_{l} \qquad [ Equation 13 ]$$

Equation 14 below can be obtained from Equation 13 and Equation 3 of the conventional comb actuator. Equation 14 is a general formula to calculate electrostatic force (F) in the vertical comb actuator 400 as illustrated in FIGS. 8 and 9 with respect to electrostatic force of the conventional comb actuator.

F=nₗ×100(%) [Equation 14]

Electrostatic force (F) is calculated using Equation 14 while the number nₗ of layers changes, so that the graph of FIG. 11 can be obtained.

As shown in the graph of FIG. 11, the electrostatic force (F) increases in proportion to the number of layers, regardless of the number of branches.

As mentioned above, as the number of layers increases, the electrostatic force (F) also increases. However, if the increase in the number of layers is excessive, structure reliability of fingers can be degraded. Therefore, an appropriate number of layers should be selected in consideration of such structural reliability. The appropriate number of layers may be selected within an area B in the graph of FIG. 11, namely, an area in which the number of layers is 3˜4. In this area, structural reliability can be maintained. Also, when the number of layers is three, electrostatic force (F) is improved by about 300% as compared to the conventional art.

As mentioned above, the comb actuator according to exemplary embodiments of the present invention generates a driving force that is greatly enhanced as compared to that of the conventional comb actuator. For example, a device, which requires three conventional comb actuators to obtain a sufficient driving force, can use only one comb actuator according to exemplary embodiments of the present invention, yet almost the same driving force can be obtained. Thus, the size of the device can be greatly reduced.

Although a comb actuator has been described as an example of a MEMS comb device according to exemplary embodiments of the present invention, the structure of the MEMS comb device according to exemplary embodiments of the present invention may be applied to a comb sensor that generates an electric signal by a relative motion between a stationary comb and a movable comb.

As described so far, using a MEMS comb device according to exemplary embodiments of the present invention in the field of actuators contributes to improving a driving force while minimizing an increase in size of the device. Thus, a device requiring a high driving force using only one comb actuator can be effectively driven, the device can be minimized, and a manufacturing process yield can be improved.

When the MEMS comb device according to exemplary embodiments of the present invention is used for an inertial sensor or an acceleration sensor, a high magnitude electric signal can be obtained upon even a subtle movement, and thus sensing sensitivity is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A micro electromechanical system (MEMS) comb device comprising:
a stationary comb fixed on a substrate;
a movable comb separated from the substrate; and
a spring movably supporting the movable comb,
wherein the stationary comb has a plurality of layers and comprises a stationary stage, and a plurality of stationary fingers which protrude from the stationary stage, the plurality of stationary fingers are separated at different intervals from the stationary stage,
the movable comb has a plurality of layers and comprises a movable stage, and a plurality of movable fingers which protrude from the movable stage, the plurality of movable fingers are separated at different intervals from the movable stage, and
the plurality of stationary fingers and the plurality of movable fingers are arranged to correspond to each other according to a reverse order relationship between the plurality of layers of the stationary fingers and the plurality of layers of the movable fingers, and the plurality of stationary fingers and the plurality of movable fingers that correspond to each other are arranged alternately with each other.

2. The device of claim 1, wherein the plurality of stationary fingers comprise stationary fingers arranged in a first layer of the plurality of layers of the stationary comb and which protrude directly from the stationary stage, and stationary fingers arranged in a second layer of the plurality of layers of the stationary comb, which comprise support fingers and have branches, and
the plurality of movable fingers comprise movable fingers arranged in a first layer of the plurality of layers of the movable comb and which protrude directly from the movable stage, and movable fingers arranged in a second layer of the plurality of layers of the movable comb, which comprise support fingers and have branches.

3. The device of claim 2, wherein the stationary fingers arranged in the first layer of the stationary comb correspond to the movable fingers arranged in the second layer of the movable comb, and
the stationary fingers arranged in the second layer of the stationary comb correspond to the movable fingers arranged in the first layer of the movable comb.

4. The device of claim 3, wherein three or more branches diverge respectively from the support fingers.

5. The device of claim 2, wherein the plurality of layers of the stationary comb comprise a third layer, and the plurality of stationary fingers are arranged in the first, the second and the third layers of the stationary fingers, and
the plurality of layers of the movable combs comprise a third layer, and the plurality of movable fingers are arranged in the first, the second and the third layers of the movable fingers,
wherein the stationary fingers arranged in the first layer of the stationary comb correspond to the movable fingers arranged in the third layer of the movable comb,
the stationary fingers arranged in the second layer of the stationary comb correspond to the movable fingers arranged in the second layer of the movable comb, and
the stationary fingers arranged in the third layer of the stationary comb correspond to the movable fingers arranged in the first layer of the movable comb.

6. The device of claim 5, wherein the stationary fingers arranged in the second layer and the third layer of the stationary comb, and the movable fingers arranged in the second layer and the third layer of the movable comb comprise branches diverging from the support fingers, wherein three or more branches diverge from the support fingers.

7. The device of claim 2, wherein the support fingers of the stationary comb and the support fingers of the movable comb have thicknesses greater than those of other fingers.

8. The device of claim 1, wherein the movable comb is disposed on a same plane as the stationary comb, and is moved in a direction parallel to an upper surface of the substrate.

9. The device of claim 1, wherein the movable comb is disposed at a different height from that of the stationary comb, and is moved in a direction perpendicular to the upper surface of the substrate.

10. The device of claim 1, wherein the MEMS comb device serves as an actuator that generates a driving force to move the movable comb by applying a voltage between the stationary comb and the movable comb.

11. The device of claim 1, wherein the MEMS comb device serves as a sensor that generates an electric signal due to a relative motion between the stationary comb and the movable comb.
